(19) United States
(12) Patent Application Publication
(10) Pub. No.: US 2008/0181065 A1
(43) Pub. Date: Jul. 31, 2008

(54) PLAYBACK SIGNAL DISTORTION COMPENSATION METHOD AND OPTICAL DISK PLAYBACK METHOD

(75) Inventor: Isao Matsuda, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/016,943

(22) Filed: Jan. 18, 2008

(30) Foreign Application Priority Data
Jan. 22, 2007 (JP) 2007-011100

(51) Int. Cl. G11B 20/00

(52) U.S. Cl. 369/47.17

(57) ABSTRACT

An object of the present invention is to appropriately cope with a tears type mark occurring in, for example, an organic dye write-once disk. A playback signal distortion compensation method is a method for compensating a distortion in a playback signal of data recorded in an optical disk, and includes the steps of: specifying part of a playback signal of a mark having a length equal to or larger than a predetermined length; and, if a specific amplitude level value that will not appear in an ideal signal is detected in the specified part of the playback signal at specific sampling timing, setting the amplitude level values detected at the specific sampling timing and predetermined sampling timing alike to predetermined level values based on the ideal signal. Owing to the compensation of the amplitude levels, a transition of amplitude level values in the signal can be approached to a transition thereof in the ideal signal. Consequently, degradation of a bit error rate can be hindered.

### BACKGROUND OF THE INVENTION

1. Field of the Invention

The present invention relates to a technology for compensating a distortion in a playback signal of data recorded in an optical disk.

2. Description of the Related Art

A high-density recoding and playback optical disk such as a write-once Blu-ray disk (abbreviated to BD-R) or a write-once HD-DVD disk (abbreviated to HD DVD-R) is structured to have a recording layer, a reflective layer, and, if necessary, a protective layer formed on one of the surfaces of an optical transparency disk-like substrate. Moreover, a spiral groove or concentric circle grooves called simply a groove or grooves are formed in one of the surfaces of the substrate in which the recording layer and reflective layer are formed, and an interspace between adjoining grooves or groove portions is formed as a convex part called a land. This type of optical disk has data recorded therein when an optical information recording and playback device irradiates recording laser light to the recording layer in the groove while causing the laser light to track the groove, and thus forms pits (hereinafter, called marks). In the thus recorded optical disk, a record mark having a length nT (which is an n integral multiple of the length T of a bit between reference channel clocks) and a portion between pits (hereinafter a space) having the length nT are repeatedly formed. Playback laser light is irradiated to an array of marks and spaces, and reflected light is converted into a playback signal, whereby playback is achieved. In the recording and playback, there are various problems. The problems will be presented below together with analogous digital technologies that have been disclosed to solve the problems.

For example, JP-A-10-198963 has disclosed a technology for reducing an offset change or an amplitude variation in a meander signal component of a radiofrequency (RF) signal. Specifically, in an optical disk playback device for reproducing information from an optical recording medium whose tracks have meandering side walls, a subtractor produces a meander signal from a playback signal under the control of a CPU on the basis of a result of demodulation based on partial response and maximum likelihood (PRML), and thus subtracts the meander signal component, which is proportional to the offset change, from the RF signal. A degree of amplification by a changeable gain amplifier is controlled based on a meander component proportional to the amplitude variation. However, JP-A-10-198963 has not disclosed a countermeasure against a problem that marks (which may be called pits) in an organic dye optical disk tend to be shaped like a tears type configuration.

Moreover, JP-A-2004-259315 has disclosed a technology for coping with a data detection error derived from an amplitude variation caused by a spacing loss that occurs during playback of record data in a magnetic tape device. Specifically, the magnetic tape device includes a reproducing head that reads a recorded signal from a recording medium, an analog-to-digital conversion means for converting a playback signal to a digital signal, and an amplitude compensation means for compensating an amplitude variation contained in the digital signal. The amplitude compensation means detects a maximum value from samples obtained from an output signal of the analog-to-digital conversion means over a certain period, and obtains the signal level. An output signal of the amplitude compensation means is amplified based on the difference of the signal level from a reference level, whereby the amplitude variation is compensated. This publication has not disclosed a countermeasure against the problem that marks (which may be called pits) in an organic dye optical disk tend to be shaped like a tears type configuration.

Incidentally, JP-A-10-198963 may be called a patent document 1, and JP-A-2004-259315 may be called a patent document 2.

As mentioned above, optical disks having an organic dye employed in a recording layer thereof (hereinafter, simply, optical disks) exhibit a property that marks tend to be shaped like a tears type configuration due to a disorder in a state of heat balance occurring during recording. Moreover, in recent years, in pursuit of a higher density (that is, a larger capacity), a transition has been made from a method in which an auto-slicing circuit is used to process data in terms of a time base on which the length of a mark is indicated to a method in which a partial response and maximum likelihood (PRML) circuit is used to process data in terms of a voltage amplitude level. In this background, a tears type mark shape that is likely to occur during formation of a long mark brings about an amplitude variation during playback. This poses a problem in that an error occurs during Viterbi decoding.

Now, a signal processing method based on PRML will be briefed below. This method is a technology for performing playback while permitting diffusion of signal energy to the positions of adjacent channel clock signals for the purpose of hindering interference between adjacent symbols. Specifically, a Viterbi decoding (which may be called maximum likelihood decoding) technology for decoding the most probable signal stream selected from a playback signal while coping with an imperfect frequency response that causes, unlike a frequency response which realizes a non-distortion condition, interference between symbols is used in combination in order to hinder interference between symbols so as to avoid deterioration in signal quality.

The foregoing problem will be described concretely. In the case of a partial response (PR) (1,2,2,1) method, generally, for example, a radiofrequency (RF) signal representing one mark (an analog signal exhibiting an amplitude level) having a length of nT has the phase thereof adjusted, and analog-to-digital converted (digitally sampled) so that the amplitude will be expressed with any of seven levels from level 0 to level 6. In the analog-to-digital conversion, when seven levels of analog values are assigned to 64 gray-scale levels (bytes) of digital values, a specific analog value can be expressed with at least seven gray-scale levels (bytes) with a variation of ±0.5 taken into consideration. Consequently, normally, a bit error is equal to or smaller than a specified value because it is appropriately compensated at the next step of Viterbi decoding.

Incidentally, when the number of gray-scale levels represented by digital values is increased to 128, 256, or 512, a specific analog value can be assigned to a large number of digital values representing 13, 26, or 54 gray-scale levels. Especially, in the case of 512 gray-scale levels, an analog value can be identified with considerably high precision.

However, since a long symbol, for example, a mark having a length of 4T or more is likely to be shaped like a tears type configuration, the amplitude of a playback signal largely deviates from an ideal amplitude level, and the playback signal cannot therefore be decoded into the most probable signal stream during Viterbi decoding. As a result, a bit error rate (BER) is degraded.

FIG. 1 graphically shows, for example, the tears type configuration of a mark having a length of 8T. The axis of abscissas of the graph indicates the sampling timing in a direction in which an optical head runs over tracks, and the axis of ordinates thereof indicates the amplitude level of a voltage. Shown in FIG. 1 are an ideal transition pattern of amplitude level values (broken line b) representing a high-to-low transition, that is, a transition in polarity of a signal during recording which causes an optical disk to get bright before a mark is recorded and to get dark after the mark is recorded, and a transition pattern of amplitude level values (broken line a) representing a transition of a signal reproduced from a tears type mark. In FIG. 1, at a sampling point No. 10, although a theoretical amplitude level is 1, the amplitude level of the playback signal is about 2 due to a distortion in the signal waveform. The amplitude level exerts an adverse effect to raise a bit error rate.

The description of the graph of a tears type mark will be supplemented. The amplitude level values indicated in the graph are obtained by irradiating laser light while running an optical head, and converting reflected light into a playback signal. The optical head is run from the inner-circumference side of an optical disk to the outer-circumference side thereof in order to measure the amplitude level values. The sampling timing comes at intervals of a certain cycle (1T). equivalent to the length from the left side of a recorded mark to the right side thereof, and an amplitude level value is measured at the sampling timing. Since the sampling timing comes at intervals of 1T, it varies depending on the length of the recorded mark. For example, in the case of the mark that has a length of 8T and that is graphically shown in FIG. 1, the amplitude level value is measured at the sampling timings Nos. 3 to 11. At the sampling timings Nos. 1 and 2, the amplitude level of a signal reproduced from an adjacent space is measured, and the signal is handled as a signal other than a signal reproduced from a mark concerned. The amplitude level value detected at each sampling timing may be regarded as a transitional value with the axis of abscissas as a time base over which the optical head is run. Moreover, the amplitude level values at the respective sampling timings are the results of measurements performed at the sampling timings, and the broken line may be regarded as the distribution of amplitude level values associated with the positions of marks. In the present specification, the former way of thinking is adopted, that is, the amplitude level value at each sampling time is regarded as a transitional value over the time base.

The precondition of the present invention is recording and playback based on the PR (1,2,2,1) method. Therefore, the amplitude of an ideal RF signal reproduced from a mark having a length of nT is expressed with any of seven levels. When sampling values sampled at sampling times that come at intervals of a length IT are plotted, any value other than values included in a transition of 3, 1, 0, 1, and 3 does not appear in the transition of amplitude level values. Based on this fact, there is provided a technology for correcting an amplitude level value of a signal reproduced from a mark, which is not any of the above values, to the amplitude level value of the ideal signal.

### SUMMARY OF THE INVENTION

An object of the present invention is to provide, for example, a technology for appropriately coping with a tears type mark formed in an optical disk.

Another object of the present invention is to provide, for example, a technology for preventing degradation of a bit error rate even when a tears type mark is recorded in an optical disk.

A playback signal distortion compensation method in accordance with the first aspect of the present invention is a method for compensating a distortion in a playback signal of data recorded in an optical disk, and includes: detecting whether a specific amplitude level value that will not appear in an ideal playback signal is sampled from the playback signal at a specific sampling timing; identifying a signal reproduced from a mark having a length equal to or larger than a predetermined length; if the specific amplitude level value is detected at the specific sampling timing, setting the specific amplitude level value at the specific sampling timing, and an amplitude level value, which is smaller than the specific amplitude level value at the specific sampling timing and which is detected at a predetermined sampling timing adjacent to the specific sampling timing, to predetermined level values based on the ideal signal.

When the amplitude level values are compensated as mentioned above, a transition pattern of amplitude levels in a playback signal can be approximated to a transition pattern of amplitude level values in an ideal signal. Degradation of a bit error rate can be hindered.

Moreover, the first aspect may include deciding, based on the transition pattern of amplitude level values in the playback signal, whether the shape of a mark is of a tapered type or a claviform type. For example, a feature that is left unaffected in a mark having a length equal to or larger than a predetermined length and having a tears type mark is used to make a decision.

At the detecting step, a decision is made on whether a specific amplitude level value that will not appear in an ideal playback signal is detected at specific sampling timing. Otherwise, a decision may be made by comparing the specific amplitude level value, which will not appear in the ideal playback signal, with one of amplitude level values detected at sampling timings preceding and succeeding the specific sampling timing. Moreover, a decision may be made by comparing the amplitude level values at sampling timings preceding and succeeding the specific sampling timing, at which the specific amplitude level value that will not appear in the ideal playback signal is detected, with each other. A decision may be made based on a displacement pattern of multiple predetermined amplitude level values at sampling timings over which the transition pattern of amplitude level values in the playback signal nearly squares with the transition pattern of amplitude level values in the ideal playback signal. Various methods may be conceivable for making a decision. Owing to the decision, the sampling timing at which an amplitude level value that should be corrected is detected can be efficiently identified, and the playback signal can be handled as a playback signal of a nearly ideal mark.

The first aspect of the present invention may include deciding based on a transition pattern of amplitude level values in a playback signal whether the shape of a mark is a tapered shape or a claviform shape. If the mark shape is of the tapered type, the specific sampling timing may be as it is or may be the sampling timing preceding the specific sampling timing. If the mark shape is of the claviform type, the specific sampling timing may be as it is or may be the sampling timing succeeding the specific sampling timing. A tears type mark of either of the types may be coped with.

The first aspect of the present invention may further include deciding whether a specific amplitude level value that will not appear in an ideal signal is detected in a playback signal, and if a decision is made that the specific amplitude level value is detected in the playback signal, identifying based on the amplitude levels, which are detected at timings preceding and succeeding the specific sampling timing at which the specific amplitude level value is detected, whether the shape of a mark is of a tapered type or a claviform type. If the mark shape is of the tapered type, the specific sampling timing may be as it is or may be the sampling timing preceding the specific sampling timing. If the mark shape is of the claviform type, the specific sampling timing may be as it is or may be the sampling timing succeeding the specific sampling timing.

Further, the foregoing predetermined sampling timing may be identified between timings over which a displacement pattern of multiple predetermined amplitude level values appears and the specific sampling timing.

A playback signal distortion compensation method in accordance with the first aspect of the present invention is a method of compensating a distortion in a playback signal of data recorded in an optical disk, including:

detecting whether a specific amplitude level value that will not appear in an ideal playback signal is sampled at a specific sampling timing;

deciding based on a transition pattern of amplitude level values in the playback signal whether the shape of a mark is of a tapered type or a claviform type;

identifying a playback signal of a mark having a length equal to or larger than a predetermined length;

if the specific amplitude level value is detected at the specific sampling timing, correcting the specific amplitude level value to a predetermined amplitude level value; and

a step of correcting the specific amplitude level value and an amplitude level value at predetermined sampling timing to predetermined level values based on the ideal signal, where the predetermined sampling timing is between the specific sampling timing and timings over which a displacement pattern of multiple predetermined amplitude level values appears.

Owing to the compensation of an amplitude level, a transition pattern can be approximated to a transition pattern of amplitude level values in an ideal signal. Consequently, degradation of a bit error rate can be hindered at a high probability.

An optical disk playback device in accordance with the second aspect of the present invention includes:

means for detecting whether a specific amplitude level value that will not appear in an ideal playback signal is sampled from a playback signal at specific sampling timing;

means for identifying a playback signal of a mark having a length equal to or larger than a predetermined length; and

means for, if the specific amplitude level value is detected at the specific sampling timing, setting the specific amplitude level value and an amplitude level value, which is detected at a predetermined sampling timing adjacent to the specific sampling timing and is smaller than the specific amplitude level value, to predetermined level values based on the ideal signal.

Even to the second embodiment of the present invention, a variation of the first aspect of the present invention can be applied.

A dedicated circuit for implementing the playback signal distortion compensation method in accordance with the first aspect of the present invention may be produced, or the playback signal distortion compensation method may be implemented in a combination of a microprocessor and a program.

A program that allows a microprocessor to execute the playback signal distortion compensation method is stored in, for example, a storage medium or a storage device such as a flexible disk, a CD-ROM, a magneto-optical disk, a semiconductor memory, or a hard disk, or a microprocessor including a memory. Moreover, the program may be distributed as a digital signal over a network or the like. The results of intermediate processing are temporarily stored in a work memory area of any of various devices.

According to the present invention, a tears type mark formed in a write-once disk of, for example, an organic dye type can be appropriately coped with.

According to another aspect of the present invention, even if a tears type mark is recorded in a write-once disk of, for example, an organic dye type, a bit error rate will not be degraded.

### BRIEF DESCRIPTION OF THE DRAWINGS

FIG. 1 is an explanatory diagram concerning an adverse effect exerted when a tears type mark is recorded;

FIG. 2 is a functional block diagram concerning an embodiment of the present invention;

FIG. 3(a) shows an example of a tapered tears type mark, and FIG. 3(b) shows an example of a claviform tears type mark;

FIG. 4 shows an example of signal waveforms observed when a tapered tears type mark is reproduced;

FIG. 5 shows an example of signal waveforms observed when a claviform tears type mark is reproduced;

FIG. 6 presents a processing flow in an embodiment of the present invention;

FIG. 7A shows an example of a signal observed when a tapered tears type mark is reproduced;

FIG. 7B shows an example of a signal observed when a tapered tears type mark is reproduced;

FIG. 7C shows an example of a signal observed when a tapered tears type mark is reproduced;

FIG. 7D shows an example of a signal observed when a claviform tears type mark is reproduced;

FIG. 7E shows an example of a signal observed when a claviform tears type mark is reproduced;

FIG. 7F shows an example of a signal observed when a claviform tears type mark is reproduced;

FIG. 8 is an explanatory diagram concerning modulation;

FIG. 9 is a graph indicating a bit error rate (BER) in relation to a modulated value observed when processing employed in the embodiment is not carried out;

FIG. 10 is a graph indicating a bit error rate (BER) in relation to a modulated value observed when the processing employed in the embodiment is carried out;

FIG. 11A shows degrees of misreading of a tears type mark occurring when the processing employed in the embodiment is not carried out, and FIG. 11B shows degrees of misreading of the tears type mark occurring when the processing employed in the embodiment is carried out;

FIG. 12 shows the relationship between a magnitude of asymmetry and a bit error rate established in an ideal state; and

FIG. 13 shows the relationship between a magnitude of asymmetry and a bit error rate established when a tears type mark is read.

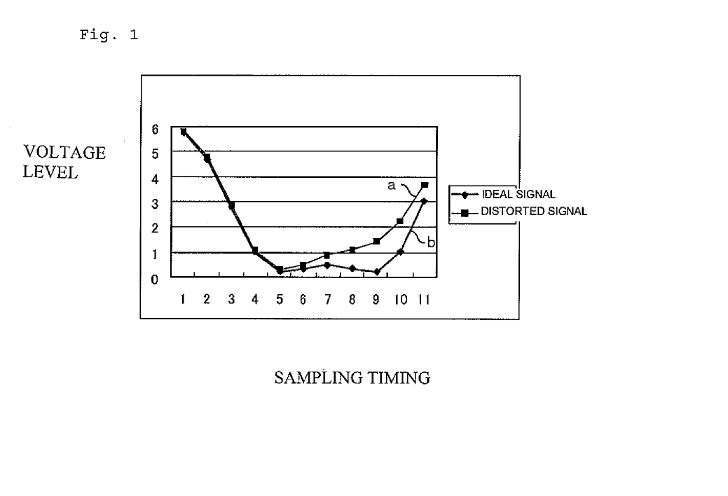

### DESCRIPTION OF THE PREFERRED EMBODIMENTS

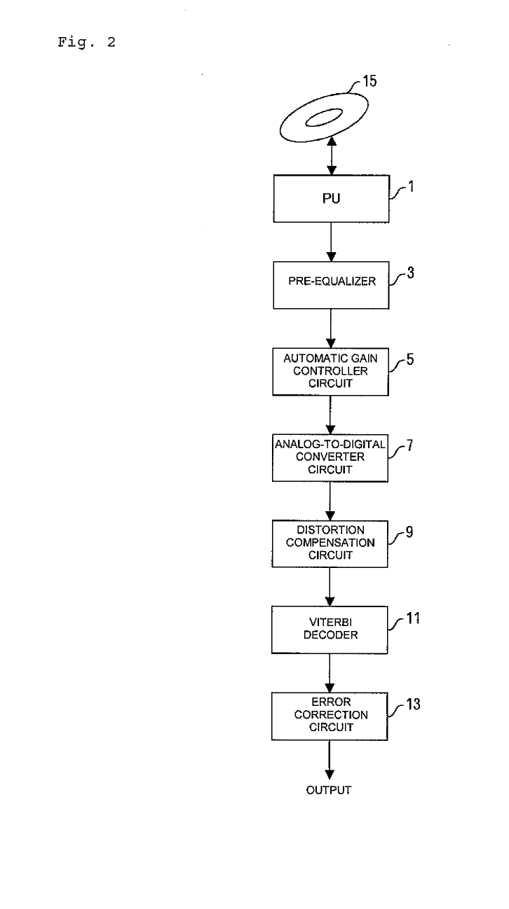

FIG. 2 is a functional block diagram of an optical disk playback device in accordance with an embodiment of the present invention. The optical disk playback device in accordance with the present embodiment includes: an optical unit (PU) 1 that irradiates laser light to an optical disk 15 which has an organic dye as a main component of a recording layer thereof and in which data has already been recorded, so as to reproduce the data; a pre-equalizer 3 that handles an electric signal, which is sent from a photodetector included in the optical unit 1, so that the electric signal can be readily converted into a digital signal at the next step; an automatic gain controller (AGC) circuit 5 that extends automatic gain control so as to suppress a variation in a gain provided by a focus error signal detection system; an analog-to-digital converter (ADC) circuit 7 that converts an analog signal into a digital signal; a distortion compensation circuit 9 that performs processing significant in the present embodiment; a Viterbi decoder 11 that implements Viterbi decoding processing, which has been described above, in an output of the distortion compensation circuit 9; and an error correction circuit 13 that implements known error correction processing in an output of the Viterbi decoder 11. The functions of the circuits other than the distortion compensation circuit 9 have little relation to the present embodiment, and are already known. The description thereof will therefore be omitted.

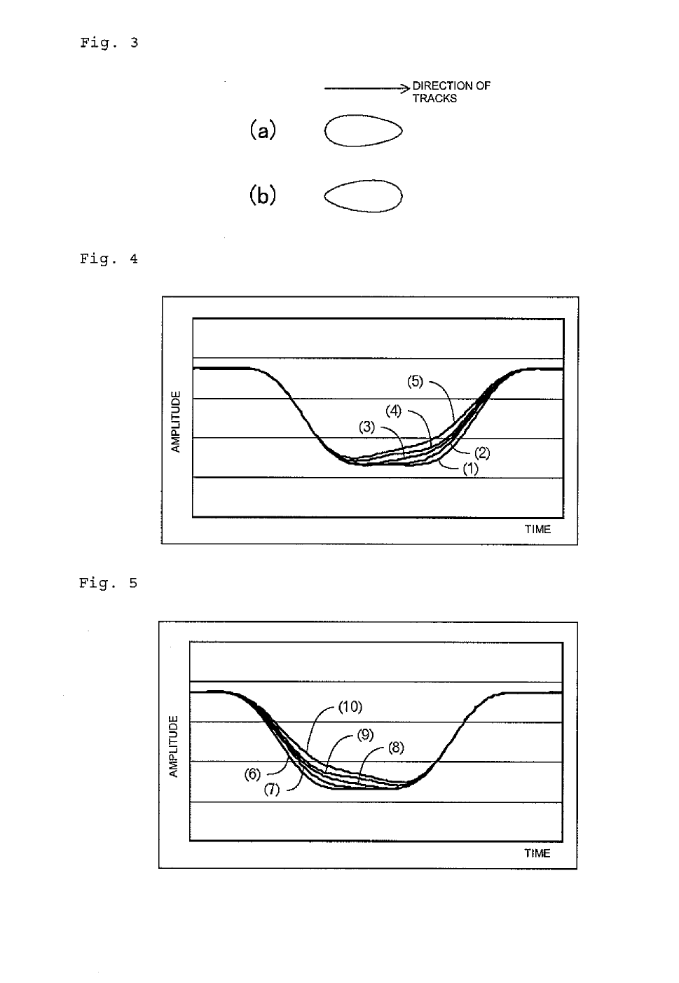

Prior to a description of the contents of processing to be performed by the distortion compensation circuit 9, the relationship between a tears type mark and a playback signal will be briefed below. The tears type mark falls into (a) a tapered mark with respect to a direction in which an optical head runs over tracks (see FIG. 3(a)) and (b) a claviform mark (see FIG. 3(b)). In the case of the tapered mark (for example, a mark having a length of 8T), a playback signal (RF signal) has a waveform like any of the ones shown in, for example, FIG. 4. In FIG. 4, the axis of ordinates indicates an amplitude level, and the axis of abscissas indicates a time, that is, a time which the optical head requires for passing through an adjoining space and a mark, and reaching another adjoining space. A waveform (1) expresses a signal in an ideal state, that is, an ideal playback signal. When the mark gets more greatly tapered, the signal is more severely distorted as expressed by waveforms (2), (3), (4), and (5) in that order. The waveforms are exhibited by signals whose recording polarities make a high-to-low transition. When the signals make a low-to-high transition, the signal waveforms are nearly vertically reversed. On the other hand, in the case of the claviform mark (for example, a mark having a length of 8T), a playback signal may have, for example, a waveform like any of the ones shown in FIG. 5. In FIG. 5, the axis of ordinates indicates an amplitude level, and the axis of abscissas indicates a time, that is, a time which the optical head requires for passing through an adjoining space and a mark, and reaching another adjoining space. A waveform (6) expresses a signal in an ideal state, that is, an ideal playback signal. When the mark gets more greatly claviform, the signal is more severely distorted as expressed by waveforms (7), (8), (9), and (10) in that order. In comparison of FIG. 4 with FIG. 5, when the marks are tapered, the first halves of the waveforms are left unaffected by the degrees of tapering, but the second halves are affected thereby. When the marks are claviform, the second halves of the waveforms are left unaffected by the degrees to which the mark is claviform, but the first halves thereof are affected thereby. In consideration of this point, the distortion compensation circuit 9 has to implement signal compensation processing.

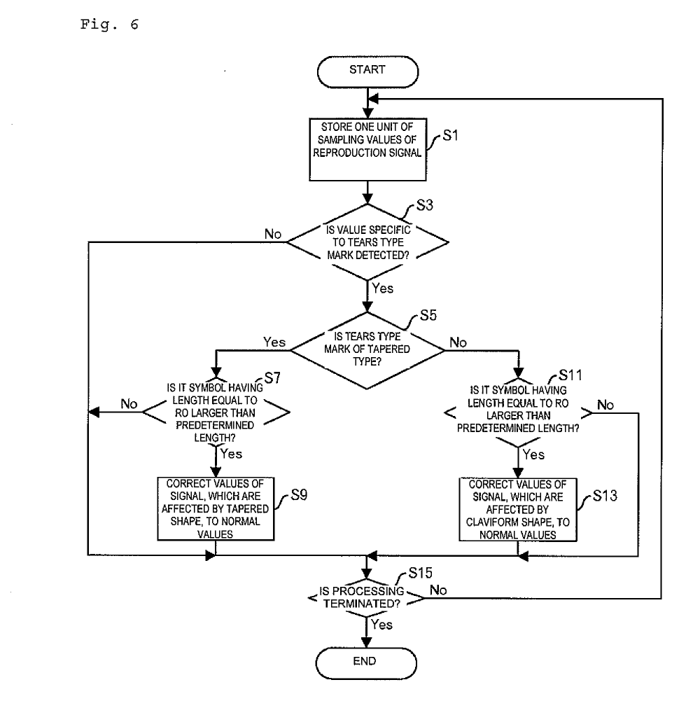

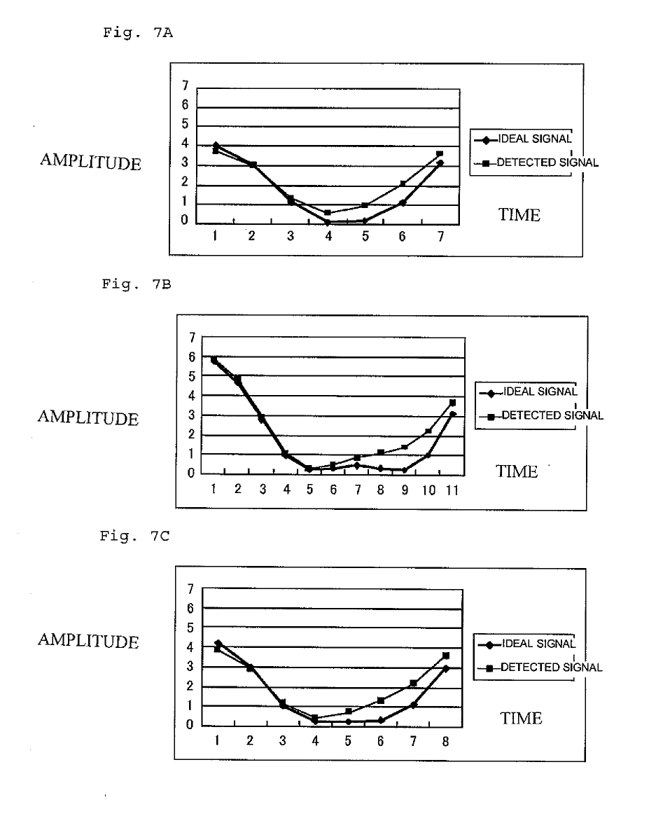

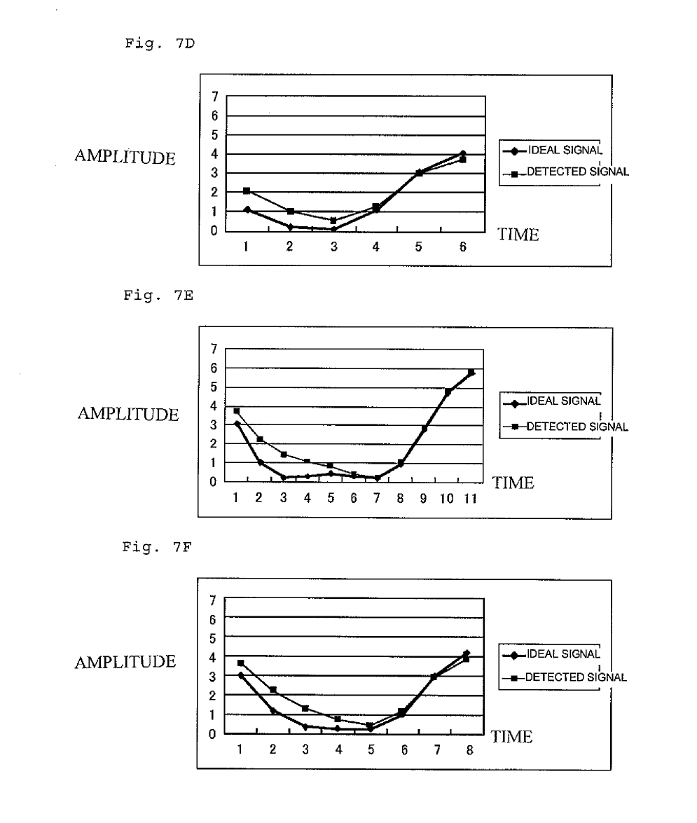

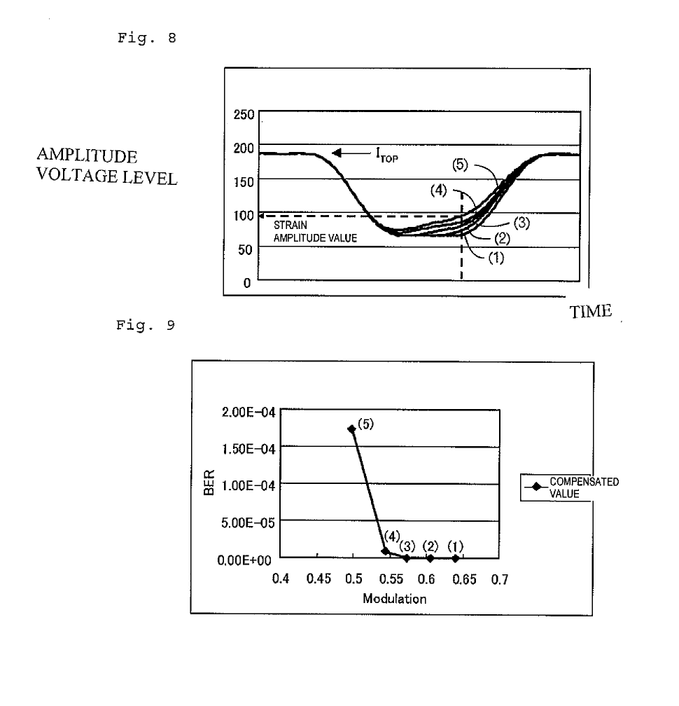

Next, the contents of processing to be performed by the distortion compensation circuit 9 will be described below in conjunction with FIG. 6 and FIG. 7. To begin with, the distortion compensation circuit 9 stores unit by unit a sampling value of a playback signal outputted from the analog-to-digital converter circuit 7 of FIG. 2 in a memory (step S1 of FIG. 6). For example, like examples shown in FIG. 7A to FIG. 7F, an amplitude level value of a sampling of the playback signal representing one mark (hereinafter, a sampling value) is identified and stored in the memory. In FIG. 7A to FIG. 7F, the axis of ordinates indicates an amplitude level, and the axis of abscissas indicates sampling timing (which may be called a sampling point) on a time base which is equivalent to a position of a mark. Among FIG. 7A to FIG. 7F, the number of sampling timings differs because of a difference in a symbol length nT. In the drawings, the range of sampling timings from the sampling timing relating to an amplitude level of 3 to the sampling timing again relating the amplitude level of 3 corresponds to a period during which a signal of a mark having a length of nT is reproduced.

Returning to FIG. 6, the distortion compensation circuit 9 thereafter decides whether a specific amplitude level value inherent to a tears type mark is included in sampling values stored in the memory (step S3). The precondition of the present embodiment is the employment of the PR (1,2,2,1) method. In this case, a sampling value of 2±0.5 is known to be the specific amplitude level value inherent to a tears type mark. Specifically, the amplitude level is a value, as described above, other than the values included in the transition of amplitude level values of 3, 1, 0, 1, and 3. Whether the above value is included in the sampling values stored in the memory is decided. If the value is not included, subsequent processing to be performed by the distortion compensation circuit 9 is not needed. Processing therefore proceeds to step S15. If a decision is made that the value is included, the sampling timing at which the value is detected is identified. The sampling timing is regarded as the specific sampling timing.

On the other hand, if a decision is made that a specific amplitude level value inherent to a tears type mark is included, whether the tears type mark is tapered or claviform is decided (step S5). Whether the tears type mark is tapered or claviform is decided based on, for example, sampling values detected at timings preceding and succeeding the specific sampling timing at which the specific amplitude level value inherent to the tears type mark is detected. Specifically, if a sampling value detected at the sampling timing immediately preceding the sampling timing at which the amplitude level value inherent to a tears type mark is detected is smaller than the sampling value detected at the immediately succeeding sampling timing, the amplitude level value inherent to the tears type mark exists in the second half of a transition pattern of amplitude level values as shown in FIG. 7A to FIG. 7C. Consequently, the tears type mark is recognized as a tapered mark. On the other hand, if a sampling value detected at the sampling timing immediately preceding the sampling timing at which the specific amplitude level value inherent to a tears type mark is detected is larger than a sampling value detected at the immediately succeeding sampling timing, the amplitude level value inherent to the tears type mark exists in the first half of the transition pattern of amplitude level values as shown in FIG. 7D to FIG. 7F. Consequently, the tears type mark is recognized as a claviform mark. Moreover, the specific amplitude level value may be compared with sampling values detected at sampling timings preceding and succeeding the sampling timing at which the specific amplitude level value is detected. A decision can be made in the same manner according to whether the difference of the specific amplitude level value from the sampling value detected at the preceding sampling timing or the difference thereof from the sampling value detected at the succeeding sampling timing is smaller. Naturally, according to whether the specific amplitude level value is compared with the sampling value at the preceding sampling timing or the sampling value at the succeeding sampling timing, a criterion is reversed.

Whether a tears type mark is tapered or claviform may be decided according to any other method. Specifically, although the first half of a transition pattern of amplitude level values detected from a tapered tears type mark or the second half of a transition pattern of amplitude level values detected from a claviform tears type mark does not differ very much from that in an ideal signal, if a displacement of sampling values in the first half or second half is a decrease, the tears type mark can be recognized as a tapered mark. If the displacement of sampling values is an increase, the tears type mark can be recognized as a claviform mark. Moreover, if the sampling timing at which a specific amplitude level value inherent to a tears type mark exists in the second half of the transition pattern beyond the center thereof, the tears type mark is tapered. If the sampling timing at which the specific amplitude level value is detected exists in the first half of the transition pattern beyond the center thereof, the tears type mark is claviform. Any other method may be adopted.

Whether a tears type mark is tapered or claviform is decided as mentioned above. If a tears type mark is recognized as a tapered mark, the distortion compensation circuit 9 decides whether a symbol having a length equal to or larger than a predetermined length is handled (step S7). When the PR (1,2,2,1) method is adopted, if a tears type mark has a length equal to or larger than 4T poses a problem, sampling values exhibit a displacement pattern that has 3 succeeded by 1. Consequently, a decision is made on whether the sampling values exhibit a displacement pattern that has 3±0.5 succeeded by 1±0.5 where 0.5 is a margin. If such a combination of sampling values does not exist, processing to be performed by the distortion compensation circuit 9 is not needed. Processing therefore proceeds to step S15.

On the other hand, if sampling values whose transition squares with a transition of amplitude levels in an ideal signal include a combination of sampling values exhibiting a displacement pattern that has 3±0.5 succeeded by 1±0.5, the distortion compensation circuit 9 implements the processing of correcting signal levels, which are caused by a tapered mark, to normal levels (step S9). Specifically, a specific amplitude level value inherent to a tears type mark detected at sampling timing is set to a predetermined level of 1. A sampling value detected at predetermined sampling timing that precedes the sampling timing at which the specific amplitude level value inherent to the tears type mark is detected, and that succeeds appearance of a combination of sampling values exhibiting a displacement pattern that has 3±0.5 succeeded by 1±0.5 is set to a predetermined level of 0.

When a transition pattern like the one shown in FIG. 7A is exhibited by a signal of a mark having a length of 5T, sampling timing No. 6 corresponds to the sampling timing at which the specific amplitude level value inherent to a tears type mark is detected. The specific amplitude level value of 2±0.5 exists in the second half of the transition pattern beyond the center thereof, and the tears type mark is therefore recognized as a tapered mark. A combination of sampling values that exhibits a displacement pattern having 3±0.5 succeeded by 1±0.5 is detected at sampling timings Nos. 2 and 3. From this fact, the tapered mark is inferred. Consequently, sampling values detected at sampling timings Nos. 4 and 5 are regarded as sampling values to be detected at predetermined sampling timings, and forcibly corrected to 0s. The sampling value at the sampling timing No. 6 is regarded as the specific amplitude level value and forcibly corrected to 1.

Likewise, when a transition pattern like the one shown in FIG. 7B is exhibited by a signal of a mark having a length of 8T, sampling timing No. 10 is the sampling timing at which the specific amplitude level value of 2±0.5 inherent to a tears type mark is detected. Since the specific amplitude level value of 2±0.5 exists in the second half of the transition pattern beyond the center thereof, the tears type mark is recognized as a tapered mark. A combination of sampling values exhibiting a displacement pattern that has 3±0.5 succeeded by 1±0.5 is detected at sampling timings Nos. 3 and 4. From this fact, the tapered mark is inferred. Consequently, sampling values detected at sampling timings Nos. 5 to 9 are forcibly corrected to 0s, and the sampling value detected at the sampling timing No. 10 is forcibly corrected to 1.

Further, when a transition pattern like the one shown in FIG. 7C is exhibited by a signal of a mark having a length of 6T, sampling timing No. 7 is the sampling timing at which the specific amplitude level value of 2±0.5 inherent to a tears type mark is detected. Since the specific amplitude level value of 2±0.5 exists in the second half of the transition pattern beyond the center thereof, the tears type mark is recognized as a tapered mark. A combination of sampling values exhibiting a displacement-pattern that has 3±0.5 succeeded by 1±0.5 is detected at sampling timings Nos. 2 and 3. From this fact, the tapered mark is inferred. Consequently, sampling values detected at sampling timings Nos. 4 to 6 are forcibly corrected to 0s, and the sampling value detected at the sampling timing No. 7 is forcibly corrected to 1.

Processing proceeds to step S15 of FIG. 6. If processing termination is instructed, the processing is terminated. If the processing termination is not instructed, processing returns to step S1.

On the other hand, if a tears type mark is recognized as a claviform mark, the distortion compensation circuit 9 decides whether a symbol having a length equal to or larger than a predetermined length is being handled (step S11). When the PR (1,2,2,1) method is employed, if a mark has a length equal to or larger than 4T that causes a tears type configuration, sampling values are known to exhibit a displacement pattern that has 1 succeeded by 3. Consequently, whether sampling values exhibit a displacement pattern that has 1±0.5 succeeded by 3±0.5 where 0.5 is a margin is decided. If such a combination of sampling values is not detected, processing to be performed by the distortion compensation circuit 9 is not needed. Processing proceeds to step S115.

On the other hand, if a combination of sampling values exhibiting a displacement pattern that has 1±0.5 succeeded by 3±0.5 is detected, the distortion compensation circuit 9 implements the processing of correcting signal values, which are affected by a claviform mark, into normal values (step S13). Specifically, a specific amplitude level value inherent to a tears type mark detected at sampling timing is set to 1. A sampling value detected at sampling timing that succeeds the sampling timing at which the amplitude level value inherent to the tears type mark is detected, and that precedes appearance of a combination of sampling values of 1±0.5 and 3±0.5 in that order is set to 0.

When a transition pattern like the one shown in FIG. 7D is exhibited by a signal of a mark having a length of 5T, sampling timing No. 1 is the sampling timing at which the amplitude level value of 2±0.5 inherent to the tears type mark is detected. Since the specific amplitude level value of 2±0.5 exists in the first half of the transition pattern beyond the center thereof, the tears type mark is recognized as a claviform mark. A combination of sampling values exhibiting a displacement pattern that has 1±0.5 succeeded by 3±0.5 is detected at sampling timings Nos. 4 and 5. From this fact, the claviform mark is inferred. Consequently, sampling values detected at sampling timings Nos. 2 and 3 are forcibly corrected to 0s, and the sampling value detected at the sampling timing No. 1 is forcibly corrected to 1.

Likewise, when a transition pattern like the one shown in FIG. 7E is exhibited by a signal of a mark having a length of 8T, sampling timing No. 2 is the sampling timing at which the amplitude level value of 2±0.5 specific to a tears type mark is detected. Since the specific amplitude level value of 2±0.5 exists in the first half of the transition pattern beyond the center thereof, the tears type mark is recognized as a claviform mark. A combination of sampling values exhibiting a displacement pattern that has 1±0.5 succeeded by 3±0.5 is detected at sampling timings Nos. 8 and 9. From this fact, the claviform mark is inferred. Consequently, sampling values detected at sampling timings Nos. 3 to 7 are forcibly corrected to 0s, and the sampling value detected at the sampling timing No. 2 is forcibly corrected to 1.

Further, when a transition pattern like the one shown in FIG. 7F is exhibited by a signal of a mark having a length of 6T, sampling timing No. 2 is the sampling timing at which the amplitude level value of 2±0.5 specific to a tears type mark is detected. Since the specific amplitude level value of 2±0.5 exists in the first half of the transition pattern beyond the center thereof, the tears type mark is recognized as a claviform mark. A combination of sampling values exhibiting a displacement pattern that has 1±0.5 succeeded by 3±0.5 is detected at sampling timings Nos. 6 and 7. From this fact, the claviform mark is inferred. Consequently, sampling values detected at sampling timings Nos. 3 to 5 are forcibly corrected to 0s, and the sampling value detected at the sampling timing No. 2 is forcibly corrected to 1.

Processing then proceeds to step S15 of FIG. 6. If processing termination is instructed, the processing is terminated. If the processing termination is not instructed, the processing returns to step S1.

By implementing the foregoing processing, signal compensation is performed for detecting a tears type mark and approaching the signal to an ideal signal. Degradation of a bit error rate can be suppressed.

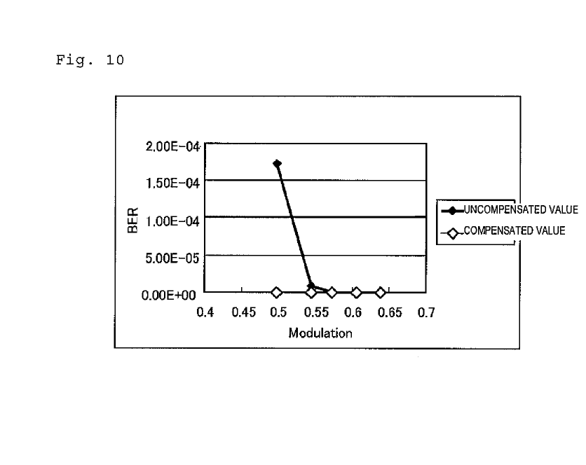

For example, as shown in FIG. 8, a value Itop and a strain amplitude value are defined. Specifically, in FIG. 8, the axis of ordinates indicates an amplitude voltage level, and the axis of abscissas indicates a time, that is, positional information on a mark. Playback signals of marks having a length of 8T include an ideal signal (1), and signals (2), (3), (4), and (5) that represent tapered marks whose degrees of tapering get larger in that order. The reference voltage Itop is a voltage value unaffected by a mark shape. The strain amplitude value is an amplitude value attained when the signal (1) begins rising.

Now, modulation shall be defined as an equation below.

Modulation=(Itop−strain amplitude)/Itop (1)

FIG. 9 shows the relationship between a modulated value provided by the equation (1) and a bit error rate (BER) attained after PRML processing is performed without implementation of the foregoing processing. In FIG. 9, the axis of abscissas indicates the modulated value, and the axis of ordinates indicates the bit error rate. In the example shown in FIG. 8, the bit error rates in the signals (1) to (3) are 0s, but the bit error rate in the signal (4) is larger than 0. The bit error rate in the signal (5) that is distorted most greatly exceeds 1.00×10⁻⁴ or a limit of a permissible range of bit error rates.

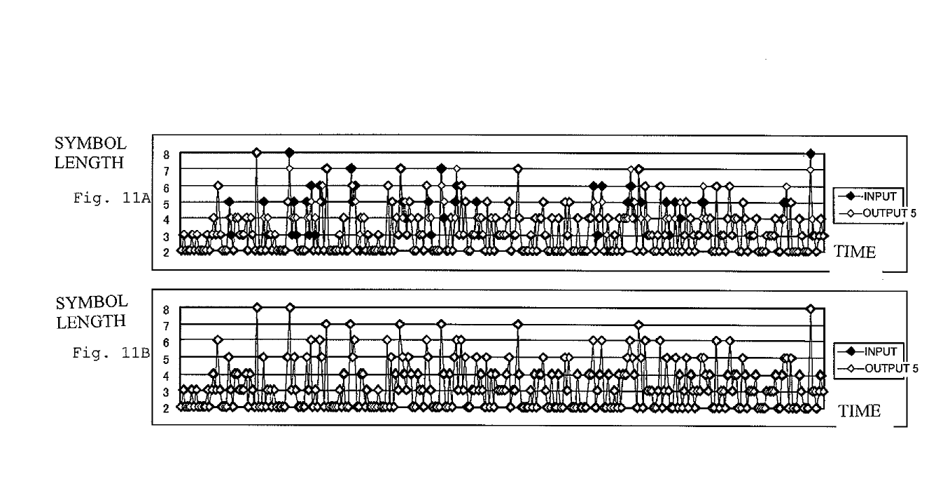

FIG. 10 shows the relationship between a modulated value and a bit error rate (BER) attained after PRML processing is performed with the aforesaid processing implemented. In FIG. 10, the axis of abscissas indicates the modulated value, and the axis of ordinates indicates the bit error rate. As seen from FIG. 10, when the aforesaid processing is implemented, the bit error rate can be suppressed to 0.

Assume that after input signals (1-7pp signals) representing symbols whose lengths range from 2T to 8T are recorded in the optical disk 15 in a situation in which the foregoing signal (5) is reproduced, playback signals are decoded. In this case, as shown in FIG. 11A, many output signals are recognized as signals representing symbols different from those represented by the input signals. In FIG. 11A, the axis of ordinates indicates a symbol length (2T to 8T), and the axis of abscissas indicates temporal information. Namely, bit error rates are shown to be high.

On the other hand, after playback signals are subjected to the aforesaid processing, when they undergo Viterbi decoding, output signals are, as shown in FIG. 11B, considered to fully square with the input signals.

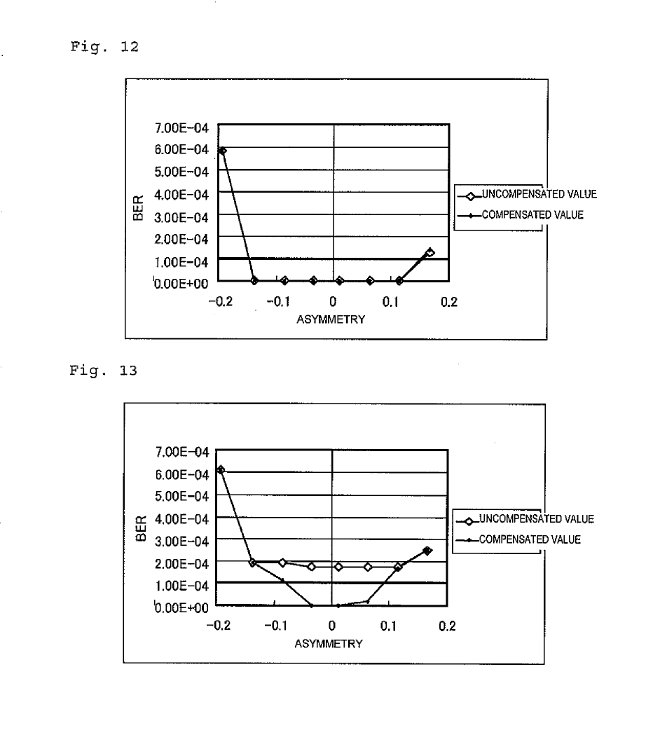

FIG. 12 shows the results of measurement performed on a variation in a bit error rate, which is derived from a variation in a magnitude of asymmetry in an ideal signal, in cases where the aforesaid processing is implemented and not implemented. In FIG. 12, the axis of abscissas indicates the magnitude of asymmetry, and the axis of ordinates indicates the bit error rate. As the magnitude of asymmetry recedes from 0, the bit error rate increases. Even in the cases where the aforesaid processing is implemented and is not implemented, since nearly the same results are obtained, the aforesaid processing does not adversely affect the bit error rate.

FIG. 13 shows the results of measurement performed on a variation in a bit error rate, which is derived from a variation in a magnitude of asymmetry in the aforesaid signal (5), in cases where the aforesaid processing is implemented and is not implemented. In FIG. 13, the axis of abscissas indicates the magnitude of asymmetry, and the axis of ordinates indicates the bit error rate. When a signal is, like the signal (5), distorted, unless the aforesaid processing is implemented, even if the magnitude of asymmetry is 0, the bit error rate gets higher. However, once the aforesaid processing is implemented, as long as the magnitude of asymmetry falls below ±0.1, a variation in the magnitude of asymmetry can be coped with. However, no effect is exerted when the magnitude of asymmetry is equal to or larger than ±0.1.

As described so far, the present embodiment is quite effective in suppressing a bit error rate.

The embodiment of the present invention has been described so far. However, the present invention is not limited to the embodiment. For example, although a description has been made of a case where the polarity of a signal makes a high-to-low transition, even when the polarity makes a reverse transition, the signal waveform is merely vertically reversed. As long as a value to be used to make a decision is appropriately determined, the same advantage can be provided.

Likewise, even when a PR (1,2,2,2,1) method is substituted for the PR (1,2,2,1) method, once a value to be used to make a decision is appropriately determined, the same advantage can be provided.

Further, an adverse effect of a tears type mark has been described to be exerted by a symbol having a length of nearly 4T or more. This has relation to the diameter of a spot of laser light to be irradiated. When the spot diameter of laser light is changed, the reference of the length of 4T will be altered.

As for the distortion compensation circuit 9, a dedicated circuit may be designed and realized. Alternatively, the distortion compensation circuit 9 may be realized with a combination of a program and a microprocessor.

Moreover, the processing flow in FIG. 6 may be modified. For example, first, whether the length of a mark is equal to or larger than a predetermined length may be decided. Thereafter, whether it is a tears type mark may be decided.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A playback signal distortion compensation method for compensating a distortion in a playback signal of data recorded in an optical disk, comprising:
detecting whether a specific amplitude level value that will not appear in an ideal playback signal is sampled from the playback signal at a specific sampling timing;
identifying a playback signal of a mark having a length equal to or larger than a predetermined length; and
if the specific amplitude level value is detected at the specific sampling timing, setting the specific amplitude level value detected at the specific sampling timing, and an amplitude level value, which is detected at a predetermined sampling timing adjacent to the specific sampling timing and is smaller than the specific amplitude level value, to predetermined level values based on the ideal playback signal.

2. The playback signal distortion compensation method according to claim 1, further comprising:
deciding, based on a transition pattern of amplitude levels in the playback signal, whether the shape of the mark is of a tapered type or of a claviform type is added to the identifying step.

3. The playback signal distortion compensation method according to claim 2, wherein:
the deciding whether the shape of the mark is of a tapered type or of a claviform type is made at the specific sampling timing at which the specific amplitude level value that will not appear in an ideal playback signal is detected.

4. The playback signal distortion compensation method according to claim 2, wherein the deciding whether the shape of the mark is of a tapered type or of a claviform type comprises:
comparing, the specific amplitude level value that will not appear in an ideal playback signal with one of an amplitude level value detected at a sampling timing preceding or succeeding the specific sampling timing at which the specific amplitude level value is detected.

5. The playback signal distortion compensation method according to claim 2, wherein the deciding whether the shape of the mark is of a tapered type or of a claviform type comprises:
comparing, amplitude level values detected at sampling timings preceding the specific sampling timing at which the specific amplitude level value that will not appear in an ideal playback signal is detected with amplitude level values detected at sampling timings succeeding the specific sampling timing at which the specific amplitude level value that will not appear in an ideal playback signal is detected.

6. The playback signal distortion compensation method according to claim 2, wherein:
the deciding whether the shape of the mark is of a tapered type or of a claviform type is based on a displacement pattern of a plurality of predetermined amplitude level values detected at sampling timings over which the transition pattern of amplitude level values in the playback signal nearly squares with a transition pattern of amplitude level values in an ideal playback signal.

7. The playback signal distortion compensation method according to claim 1, further comprising deciding, based on the transition pattern of amplitude level values in the playback signal, whether the shape of the mark is of a tapered type or of a claviform type, wherein:
when the mark is of the tapered type, the predetermined sampling timing is a sampling timing preceding the specific sampling timing; and
when the mark is of the claviform type, the predetermined sampling timing is a sampling timing succeeding the specific sampling timing.

8. The playback signal distortion compensation method according to claim 1, further comprising:
deciding whether the specific amplitude level value that will not appear in an ideal playback signal is detected in a playback signal; and
if a decision is made that the specific amplitude level value is detected in the playback signal, specifying according to amplitude levels detected at sampling timings preceding and succeeding the specific sampling timing at which the specific amplitude level value is detected, whether the shape of the mark is of a tapered type or of a claviform type, wherein
when the mark is of the tapered type, the predetermined sampling timing is a sampling timing preceding the specific sampling timing; and
when the mark is of the claviform type, the predetermined sampling timing is a sampling timing succeeding the specific sampling timing.

9. The playback signal distortion compensation method according to claim 1, wherein the predetermined sampling timing is between sampling timings over which a displacement pattern of a plurality of predetermined amplitude level values appears and the specific sampling timing.

10. A playback signal distortion compensation method for compensating a distortion in a playback signal of data recorded in an optical disk, comprising:
detecting whether a specific amplitude level value that will not appear in an ideal playback signal is sampled from the playback signal at specific sampling timing;
deciding based on a transition pattern of amplitude levels in the playback signal whether the shape of the mark is of a tapered type or of a claviform type;
identifying a playback signal of a mark having a length equal to or larger than a predetermined length;
if the specific amplitude level value is detected at the specific sampling timing, correcting the specific amplitude level value to a predetermined amplitude level value; and
correcting an amplitude level value detected at a predetermined sampling timing to a predetermined level value based on the ideal playback signal, wherein the predetermined sampling timing is between the specific sampling timing and sampling timings over which a displacement pattern of a plurality of predetermined amplitude level values appears.

11. An optical disk playback device comprising:
means for detecting whether a specific amplitude level value that will not appear in an ideal playback signal is sampled from a signal reproduced from an optical disk;
means for identifying a playback signal of a mark having a length equal to or larger than a predetermined length;
means for, if the specific amplitude level value is detected at the specific sampling timing, setting the specific amplitude level value detected at the specific sampling timing, and an amplitude level value, which is detected at a predetermined sampling timing adjacent to the specific sampling timing and is smaller than the specific amplitude level value at the specific amplitude timing, to predetermined level values based on the ideal playback signal.

12. The optical disk playback device according to claim 11, wherein the identifying means comprises means for deciding whether a displacement pattern of a plurality of predetermined amplitude level values appears in the playback signal.

13. The optical disk playback device according to claim 11, further comprising:
means for deciding based on a transition pattern of amplitude level values in the playback signal whether the shape of the mark is of a tapered type or of a claviform type, wherein
when the mark is of the tapered type, the predetermined sampling timing is a sampling timing preceding the specific sampling timing;
when the mark is of the claviform type, the predetermined sampling timing is a sampling timing succeeding the specific sampling timing.

14. The optical disk playback device according to claim 11, further comprising:
means for deciding whether the specific amplitude level value that will not appear in an ideal playback signal is detected in a playback signal; and
means for, if the specific amplitude level value is detected in the playback signal, specifying according to amplitude levels detected at sampling timings, which precede and succeed the specific sampling timing at which the specific amplitude level is detected, whether the shape of the mark is of a tapered type or of a claviform type, wherein
when the mark is of the tapered type, the predetermined sampling timing is a sampling timing preceding the specific sampling timing; and
when the mark is of the claviform type, the predetermined sampling timing is a sampling timing succeeding the specific sampling timing.

15. The optical disk playback device according to claim 12, wherein the predetermined sampling timing is between sampling timings over which a displacement pattern of a plurality of predetermined amplitude level values appears and the specific sampling timing.

16. An optical disk playback method for compensating a distortion in a playback signal of data recorded in an optical disk, comprising:
detecting whether a specific amplitude level value that will not appear in an ideal playback signal is sampled from the playback signal at a specific sampling timing;
deciding based on a transition pattern of amplitude level values in the playback signal whether the shape of the mark is of a tapered type or of a claviform type;
identifying a playback signal of a mark having a length equal to or larger than a predetermined length;
if the specific amplitude level value is detected at the specific sampling timing, correcting the specific amplitude level value to a predetermined amplitude level value; and
correcting an amplitude level value detected at a predetermined sampling timing to a predetermined level value based on the ideal playback signal, wherein the predetermined sampling timing is between the specific sampling timing and sampling timings over which a transition pattern of a plurality of predetermined amplitude level values appears.

17. An optical disk playback device comprising:
an optical unit configured to irradiate light to an optical disk and reproduce a signal representing data recorded on the disk;
detection logic configured to detect whether a specific amplitude level value that will not appear in an ideal playback signal is sampled from a signal reproduced from an optical disk;
identification logic configured to identify a playback signal of a mark having a length equal to or larger than a predetermined length;
correction logic configured to set the specific amplitude level value detected at the specific sampling timing and an amplitude level value, which is detected at a predetermined sampling timing adjacent to the specific sampling timing and is smaller than the specific amplitude level value at the specific amplitude timing, to predetermined level values based on the ideal playback signal, if the specific amplitude level value is detected at the specific sampling timing.

18. The optical disk playback device according to claim 17, wherein the identification logic is configured to decide whether a displacement pattern of a plurality of predetermined amplitude level values appears in the playback signal.

19. The optical disk playback device according to claim 17, further comprising:
decision logic configured to decide based on a transition pattern of amplitude level values in the playback signal whether the shape of the mark is of a tapered type or of a claviform type, wherein
when the mark is of the tapered type, the predetermined sampling timing is a sampling timing preceding the specific sampling timing;
when the mark is of the claviform type, the predetermined sampling timing is a sampling timing succeeding the specific sampling timing.

20. The optical disk playback device according to claim 17, further comprising:
decision logic configured to decide whether the specific amplitude level value that will not appear in an ideal playback signal is detected in a playback signal; and
determination logic configured to specify according to amplitude levels detected at sampling timings, which precede and succeed the specific sampling timing at which the specific amplitude level is detected, whether the shape of the mark is of a tapered type or of a claviform type, if the specific amplitude level value is detected in the playback signal, wherein
when the mark is of the tapered type, the predetermined sampling timing is a sampling timing preceding the specific sampling timing; and
when the mark is of the claviform type, the predetermined sampling timing is a sampling timing succeeding the specific sampling timing.

21. The optical disk playback device according to claim 20, wherein the predetermined sampling timing is between sampling timings over which a displacement pattern of a plurality of predetermined amplitude level values appears and the specific sampling timing.
